(19) United States
(12) Patent Application Publication
(10) Pub. No.: US 2004/0114460 A1
(43) Pub. Date: Jun. 17, 2004

(54) Method and device for mixing products

(76) Inventor: Jorg M List, Pratteln (CH)

Correspondence Address: BACHMAN & LAPOINTE, P.C., 900 CHAPEL STREET, SUITE 1201, NEW HAVEN, CT, 06510, US

(21) Appl. No.: 10/468,554

(22) PCT Filed: Feb. 6, 2002
(86) PCT No.: PCT/EP02/01208

(30) Foreign Application Priority Data
Feb. 26, 2002 (DE) 101 09 283.0

(51) Int. Cl. B01F 7/00

(52) U.S. Cl. 366/312; 366/301

(57) ABSTRACT

The invention relates to a method for mixing products, particularly viscous pasty products, in a mixing container (1) by means of at least two exchangeable mixers (7, 8) protruding therein, respectively comprising a mixing shaft (9) on which mixing elements (10, 12, 13) extend radially therefrom and which touch each other. According to the inventive method, the mixing elements (10, 12, 13) are used to perform mutual cleaning, clean the surface of the mixing shafts (7, 8) and/or a clean the inner surface of the container, removing products sticking thereto. At least one mixer (7, 8) performs an orbital movement in the container (1).

The invention relates to a process for mixing products, in particular high-viscosity pasty products, in a mixing vessel by means of at least two agitators which are immersed in the mixing vessel and each of which has an agitator shaft from which mixing elements project approximately radially and mesh with one another.

Mixers in varied form and design are known and are available on the market. Using them, a desired product is mixed or a plurality of constituents of a product are mixed together. In addition, using them, a thermal or chemical treatment of a product can take place, for example to produce adhesives, sealing compounds and other high-viscosity, poorly-flowing products, in industry frequently what are termed intensive planetary mixers are used. These mixers consist of a vertical cylindrical vessel having a flat bottom in which mixing elements rotate which are driven from the top and are arranged vertically. These mixing elements frequently consist of two intermeshing co-rotating or contra-rotating elements which in addition to their own rotation carry out an orbital motion in the vessel. This motion sweeps the entire vessel and the product is intensively mixed at each point.

However, in practice it has been found that in particular in the case of very highly viscous compositions which are no longer flowable, the mixing action of the stirrer elements is deficient and, in particular, the discharge of the product from the vessel is unsatisfactory. Whereas the discharge speed has been significantly improved by building in a discharge screw having a large intake orifice on the vessel bottom, the residual emptying still leaves something to be desired. Generally, at most only 90% of the product can be discharged, and the residual 10% is principally stuck to the agitator elements.

It is an object of the present invention to achieve optimum residual emptying and at the same time to improve the mixing action.

The solution to this object starts from the fact that the mixing elements carry out mutual cleaning, clean the surface of the agitator shafts and/or clean off an inner surface of the vessel from product adhesion.

Cleaning of this type is known, for example, in the case of horizontal mixing kneaders which have two inter-meshing self-cleaning mixing and kneading shafts. Examples of the appropriate geometries of such mixing and kneading shafts are described extensively in EP 0 517 068 B1, but the invention is not to be restricted hereby. There are a multiplicity of mixing kneaders which are concerned with the problem of cleaning of the surfaces. A number of such mixing kneaders is described in the prior art for EP 0 517 068 B1.

However, in the context of the present invention, it is not envisaged to place the agitator geometries known from the mixing kneaders vertically, but rather also to carry out an orbital motion with the agitators in the vessel. This means that at least one agitator circles the other, but preferably both agitators circle each other with simultaneous rotary motion in the vessel. This motion ensures that even in the case of relatively large vessels, the inner surface of the vessel is swept, so that the inner surface is cleaned off. These surfaces running parallel to the axis are cleaned off principally by mixing bars which represent the outer elements of the mixing element. These mixing bars can likewise run parallel to the axis or at an inclination, which can also affect the speed with which the product is transported from the feed port to the discharge orifice. For example, the mixing bars can be disposed at an incline toward the flow direction of the product, so that the flow direction is braked or the product is again somewhat lifted.

This inventive concept of the motion of the agitator or agitators during simultaneous rotation applies, moreover, not only to vertically disposed agitators, but also to those disposed at an incline or horizontally. The scope of the present invention also encompasses these cases.

These mixing bars also have the object of cleaning the agitator shaft of the other respective agitator. Here they sweep close past the agitator shaft. For this purpose, it can prove to be advisable to rotate the agitator shafts at different speeds. Furthermore, the agitator shafts can be co-rotating or contra-rotating. All this is to be within the scope of the inventive concept.

Preferably, the mixing bars are seated on a peripheral surface of disk elements. The disk elements not only improve the mixing action, but using the disk elements a thermal treatment of the products can also take place if the disk elements are heated or cooled.

Moreover, the product, on meeting the disk elements, receives a horizontal component, with the product having to be transported a further distance horizontally to flow round the disk elements. This also significantly improves the mixing action.

To clean these disk elements, the mixing bars preferably have mixing vanes on each side which run radially to the agitator shaft. These mixing vanes sweep close along the disk elements and clean these off.

The two agitators are preferably connected to a planetary drive, via which the agitator rotation is effected. Furthermore, a drive is also provided which allows at least one agitator to rotate around the other. For example, for this purpose, one agitator could remain approximately fixed at the center, while the other agitator rotates around it, also cleaning off the inner wall of the vessel. However, preferably, both agitators are also movable in the vessel.

Preferably a lifting device is to be assigned to the entire agitator, so that the agitator can be taken out of the vessel for cleaning.

This inventive apparatus, owing to the great number of mixing bars and the kinematics of meshing, produces a multiplicity of shear gaps and an intensive product motion which lead to shortened mixing/kneading times. The use of the inventive mixer is advantageous in particular for producing high-viscosity adhesive and sealing compositions based on polyurethane or silicone.

Mixtures of this type have very varied purposes. The first to mention is evaporation with solvent recovery, which is performed batchwise or continuously and frequently also under reduced pressure. By this means, for example, distillation residues and, in particular, toluene diisocyanates are treated, but also production residues having toxic or high-boiling solvents from the chemical industry and pharmaceutical production, wash solutions and coating slurries, polymer solutions, elastomer solutions from solvent polymerization, adhesives and sealing compounds.

Using the apparatuses, in addition, continuous or batchwise contact drying is carried out of water-moist and/or solvent-moist products, frequently likewise under reduced pressure. The use is intended, especially, for pigments, dyes, fine chemicals, additives, such as salts, oxides, hydroxides, antioxidants, temperature-sensitive drug and vitamin products, active compounds, polymers, synthetic rubbers, polymer suspensions, latex, hydrogels, waxes, pesticides and residues of chemical or pharmaceutical production, such as salts, catalysts, slags, waste lyes. These processes are also used in food production, for example in the production and/or treatment of block milk, sugar substitutes, starch derivatives, alginates, for treating industrial sludges, oil sludges, biosludges, paper sludges, coating sludges and generally for treating adhesive, crust-forming high-viscosity products, waste products and cellulose derivatives.

In mixers, degassing and/or devolatilization can take place. This is applied to polymer melts, after condensation of polyester or polyamide melts, to spinning solutions for synthetic fibers and to polymer or elastomer granules or powders in the solid state.

In a mixer, a polycondensation reaction can take place, usually continuously and usually in the melt, and is used, especially, in the treatment of polyamides, polyester, polyacetates, polyimides, thermoplastics, elastomers, silicones, urea resins, phenol resins, detergents and fertilizers.

A polymerization reaction can also take place, likewise usually continuously. This is applied to polyacrylates, hydrogels, polyols, thermoplastic polymers, elastomers, syndiotactic polysterol and polyacrylamides.

Quite generally, solid/liquid reactions and multiphase reactions can take place in the mixer. This applies especially to back-reactions, in the treatment of hydrofluoric acid, stearates, cyanates, polyphosphates, cyanuric acids, cellulose derivatives, cellulose esters, cellulose ethers, polyacetal resins, sulfanilic acids, Cu-phthalocyanins, starch derivatives, ammonium polyphosphates, sulfonates, pesticides and fertilizers.

Furthermore, solid/gas reactions (for example carboxylation) or liquid/gas reactions can take place. This is used in the treatment of acetates, azides, Kolbe-Schmitt reactions, for example BON, Na salicylates, parahydroxy-benzoates and pharmaceutical products.

Liquid/liquid reactions take place in neutralization reactions and transesterification reactions.

Dissolution and/or degassing in such mixers takes place in spinning solutions for synthetic fibers, polyamides, polyesters and celluloses.

What is termed flushing takes place in the treatment or manufacture of pigments.

A solid-state recondensation takes place in the production or treatment of polyester and polyamides, a continuous slurrying, for example in the treatment of fibers, for example cellulose fibers, with solvents, crystallization from the melt or from solutions in the treatment of salts, fine chemicals, polyols, alkoxides, compounding, mixing (continuous and/or batchwise) in polymer mixtures, silicone compounds, sealing compounds, fly ash, coagulation (in particular continuous) in the treatment of polymer suspensions.

In a mixer, multifunctional processes can also be combined, for example heating, drying, melting, crystallizing, mixing, degassing, reacting, all of these continuously or batchwise. Substances which are produced or treated by this means are polymers, elastomers, inorganic products, residues, pharmaceutical products, food products, printing inks.

In mixers, vacuum sublimation/desublimation can also take place, whereby chemical precursors, for example anthraquinone, metal chlorides, organometallic compounds etc. are purified. In addition, pharmaceutical intermediates can be produced.

A continuous carrier gas desublimation takes place, for example, in the case of organic intermediates, for example anthraquinone and fine chemicals.

Further advantages features and details of the invention result from the following description of preferred exemplary embodiments and on the basis of the drawing; in the drawing

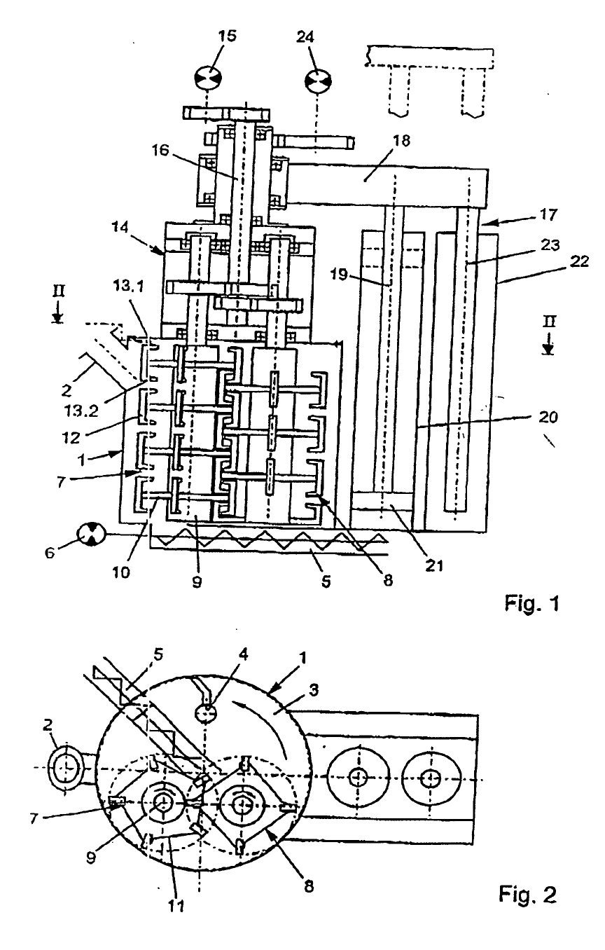

FIG. 1 shows a longitudinal section through an inventive apparatus for mixing products;

FIG. 2 shows a cross section through the apparatus according to FIG. 1 along line II-II.

An inventive apparatus for mixing products has a mixing vessel 1. In the upper region of the mixing vessel 1 may be seen a feed port 2 for the product, while in a bottom 3 (see FIG. 2) of the vessel 1 a discharge orifice 4 for the mixed product is situated. To this discharge orifice 4 is connected a discharge screw 5. It is driven by a corresponding drive 6.

In the mixing vessel 1 are situated two agitators 7 and 8 which are constructed similarly. Each agitator has an agitator shaft 9 on which are situated a plurality of axially spaced disk elements 10. On a peripheral surface 11 of the disk element 10 are located mixing bars 12 which run approximately parallel to the shaft 9. Mixing vanes 13.1 and 13.2 orientated towards the shaft 9 extend radially on both sides. The arrows in FIG. 2 indicate that the two agitators 7 and 8 rotate clockwise in the same direction.

Both agitators 7 and 8 are connected to the planetary drive 14 which ensures that the two agitators 7 and 8 carry out a rotary motion in the mixing vessel 1. For this purpose the planetary drive 14 is connected to a drive 15 which is shown only diagrammatically.

A corresponding drive shaft 16 between drive 15 and planetary drive 14 is engaged by a lifting device 17. For this the drive shaft 16 is connected to a crossarm 18 which in turn is connected to a piston rod 19. The piston rod 19 engages in a cylinder 20 and ends there with a piston 21 which can be moved in the cylinder 20 under the pressure of a corresponding pneumatic or hydraulic fluid.

For better guidance, next to the cylinder 20 is further provided a guide cylinder 22 for a guide column 23, which likewise is connected to the crossarm 18.

The rotary motion of the agitators 7 and 8 is effected via the drive 15, and an orbital motion of the entire unit of both agitators 7 and 8 in the mixing vessel 1 is effected by a further drive 24.

The mode of functioning of the present invention is as follows:

To mix a product the two drives 15 and 24 are actuated, so that the agitator of the two agitators 7 and 8 moves in the mixing vessel and at the same time the agitators 7 and 8 are also rotated.

A product to be treated is fed via the feed port 2 and passes into the mixing vessel 1. Here it is treated by the agitators 7 and 8 or the mixing elements, an intensive mixing, and if appropriate a kneading, also taking place. It is envisaged here to heat at least parts of the mixing elements and also the agitator shafts 9, so that a thermal treatment of the product can also be performed.

The design of the mixing elements avoids caking of the product to the individual surfaces. These also include the surfaces parallel to the axis, that is to say the surfaces of the agitator shafts 9 and the inner surfaces of the mixing vessel 1. These surfaces are cleaned off by the mixing bars 12, as is described, for example, in EP 0 517 068 B1.

In addition, the surfaces running radially are also cleaned off, and in particular the disk elements 10. This takes place essentially via the mixing vanes 13, which, on rotation, sweep closely past the surfaces of the disk elements 10.

The product thus treated passes to the discharge orifice 4 and is discharged via the discharge screw 5.

If, for example, the mixing vessel is to be cleaned owing to treatment of another product, the piston 21 in the lifting device 17 is pressurized and the crossarm 18 and, together therewith, the planetary drive and the agitators 7 and 8 are lifted out of the mixing vessel, as is indicated by dot-dash lines. Then, both the mixing elements and the mixing vessel 1 can be cleaned.

1. A process for mixing products, in particular high-viscosity pasty products, in a mixing vessel (1) by means of at least two agitators (7, 8) which are immersed in the mixing vessel (1) and each of which has an agitator shaft (9) from which mixing elements (10, 12, 13) project approximately radially and mesh with one another, characterized in that the mixing elements (10, 12, 13) carry out mutual cleaning, clean the surface of the agitator shafts (7, 8) and/or clean off an inner surface of the vessel from product adhesion.

2. The process as claimed in claim 1, characterized in that an orbital motion is carried out by at least one agitator (7, 8) in the vessel (1).

3. The process as claimed in claim 1 or 2, characterized in that the agitators (7, 8) are introduced approximately vertically into the vessel (1) and are rotated in this position.

4. An apparatus for carrying out the process as claimed in one of claims 1 to 3, characterized in that a mixing element has at least one mixing bar (12) running approximately parallel or at an incline to the agitator shaft (7, 8).

5. The apparatus as claimed in claim 4, characterized in that mixing vanes (13.1, 13.2) project off from the mixing bar (12) on one side or both sides, directed approximately radially toward the agitator shaft (7, 8).

6. The apparatus as claimed in claim 4 or 5, characterized in that one or more mixing bars (12) are placed on the peripheral surface (11) of a disk element (10) which envelopes the agitator shaft (7, 8).

7. The apparatus as claimed in at least one of claims 4 to 6, characterized in that one agitator (7) rotates in a stationary position, and the other agitator (8) circles this agitator in a rotating manner.

8. The apparatus as claimed in at least one of claims 4 to 6, characterized in that both agitators (7, 8) circle, rotating, in the vessel (1).

9. The apparatus as claimed in claim 7 or 8, characterized in that the agitators (7, 8) are connected to a planetary drive (14).

10. The apparatus as claimed in at least one of claims 4 to 9, characterized in that a lifting device (17) is assigned to at least one agitator (7, 8).

11. The apparatus as claimed in at least one of claims 4 to 10, characterized in that, in the upper region of the vessel (1), a feed port (2) for the product is provided and, in the lower region, a discharge screw (5) is provided.
